(19) United States
(12) Patent Application Publication
(10) Pub. No.: US 2011/0094666 A1
(43) Pub. Date: Apr. 28, 2011

(54) Antenna Manufacturing Method

(76) Inventors: Yuan-Cheng Sun, Taipei Hsien (TW); Chia-Tien Li, Taipei Hsien (TW)

(21) Appl. No.: 12/841,183

(22) Filed: Jul. 22, 2010

(30) Foreign Application Priority Data
Oct. 23, 2009 (TW) 098135893

(51) Int. Cl. B29C 65/72

(52) U.S. Cl. 156/245

(57) ABSTRACT

An antenna manufacturing method includes printing an antenna pattern on a film, and forming a substrate on the film via an in-mold forming process.

### BACKGROUND OF THE INVENTION

1. Field of the Invention

The present invention relates to a method of manufacturing an electronic component, and more particularly, to a method of manufacturing an antenna.

2. Description of the Prior Art

Recently, the concept of mobile Internet has been gradually popular in the regular life, and in pursuit of being easy to carry, portable electronic products, such as cellular phones or notebooks, etc., have been developed toward small size and less space occupation. Therefore, a size of an antenna which is used for transmitting and receiving radio signal in the electronic product has to be decreased, and also characteristics of the antenna, such as a good quality of transmitting and receiving and low-cost has to be took into consideration in both antenna design and production.

Generally, an antenna of a notebook is formed by a bent iron piece or is printed on a printed circuit board (PCB) with a signal cable distributed in a front casing of the notebook. Since the price of iron and PCB has been remaining steady, the cost of manufacturing the antenna with the foregoing methods is difficult to be decreased. Moreover, for a compact (such as 8 inches) notebook product, the size of the antenna is still not met the ideal small size and a large portion of the front casing space is thereby occupied by the antenna.

For example, please refer to FIG. 1, which is a layout diagram of an antenna in a notebook 10 according to the prior art. In the notebook 10, an antenna 12 is fixed inside a front casing 14 and receives transmission signals from a host 18 by a feeding cable 16. Since the antenna 12 is a three-dimensional antenna made of iron piece or a printed antenna, space for placing the antenna 12 has to be arranged in the front casing 14 in advance. In other words, the space, confined by the front casing 14, available for the antenna is restricted by arrangement of other components (such as panel, circuit, and wires).

### SUMMARY OF THE INVENTION

Therefore, the present invention provides an antenna manufacturing method to decrease the available space limitation and cost.

An embodiment of the invention discloses an antenna manufacturing method. The method includes printing an antenna pattern comprising a radiation pattern and a feeding terminal on a film, and forming a substrate on the film via an in-mold forming process.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a layout diagram of an antenna according to the prior art.

FIG. 2 is a flowchart of an antenna manufacturing process of the present invention.

FIG. 3A-3E are flowcharts of an antenna manufacturing process according to an embodiment of the invention.

FIG. 4 is a schematic diagram of an antenna according to an embodiment of the invention.

FIG. 5 is a waveform diagram of antenna radiation efficiency of FIG. 4.

FIG. 6 is a waveform diagram of antenna voltage standing wave ratio of FIG. 4.

### DETAILED DESCRIPTION

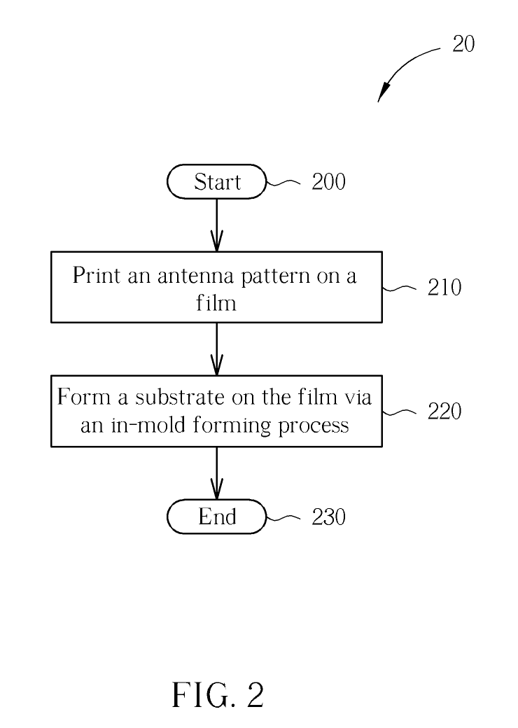

Please refer to FIG. 2, which is a flowchart of an antenna manufacturing process 20 according to an embodiment of the invention. The antenna manufacturing process 20 includes the following steps:

Step 200: Start.

Step 210: Print an antenna pattern on a film.

Step 220: Form a substrate on the film via an in-mold forming process.

Step 230: End.

According to the antenna manufacturing process 20, the embodiment of the invention first prints a pre-designed antenna pattern on the film, and then forms the substrate on the film via the in-mold forming process, to make the antenna pattern embedded between the film and the substrate closely. The concept of the in-mold forming process is that a constant amount of plastic grains is intermittently heated for melt, and then the melted plastic grains are injected into a cavity of a pre-designed mold. The melted plastic grains flows on the surface of the film and fills the cavity of, and after the melted plastic grains is cool down and turned into solid, the pre-designed antenna product is obtained by mold opening.

The antenna pattern can be printed by sliver ink, which at least includes a radiation pattern and a feeding terminal. The radiation pattern may be multiple-band or single-band radiator, used for radiating or receiving certain frequency band(s). The feeding terminal is used for receiving desired transmission signal and may be coupled to a feeding cable for receiving a feeding signal from a radio frequency (RF) circuit. The formed substrate can be a casing of a communication product, such as notebook, cell phone, etc. Therefore, for the communication product, the antenna formed via the film printing and the in-mold forming process can utilize the flat space of the casing, and thereby more space are available for placing circuit or wires.

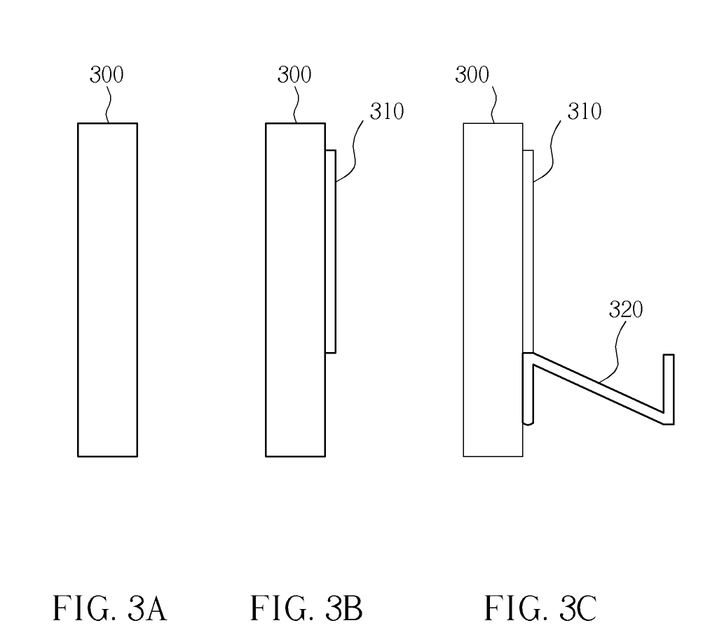

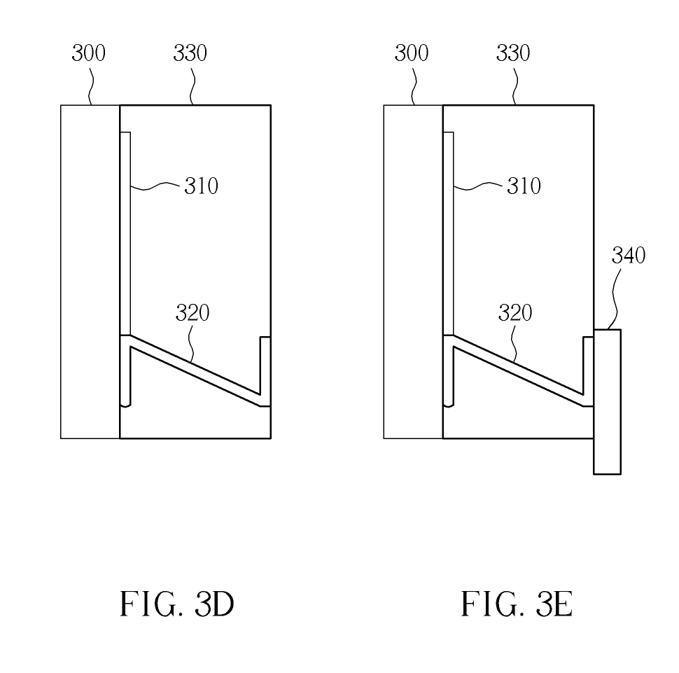

Please refer to FIGS. 3A-3E, which are flowcharts of an antenna manufacturing process according to an embodiment of the present invention. FIG. 3A shows a vertical side-view of a film 300. FIG. 3B shows an antenna pattern 310 printed on the film 300. In FIG. 3C, a metal spring 320 is bound to a predetermined feeding terminal of the antenna pattern 310, and then a substrate 330 as shown in FIG. 3D is formed on the film 300 via in-mold forming process, where a part of the metal spring 320 is exposed on the substrate 330, and the rest of parts are embedded in the substrate 330. In FIG. 3E, a feeding cable 340 is welded to the exposed part of the metal spring 320, and thereby the transmission signal can feed into the antenna pattern 310 through the metal spring 320.

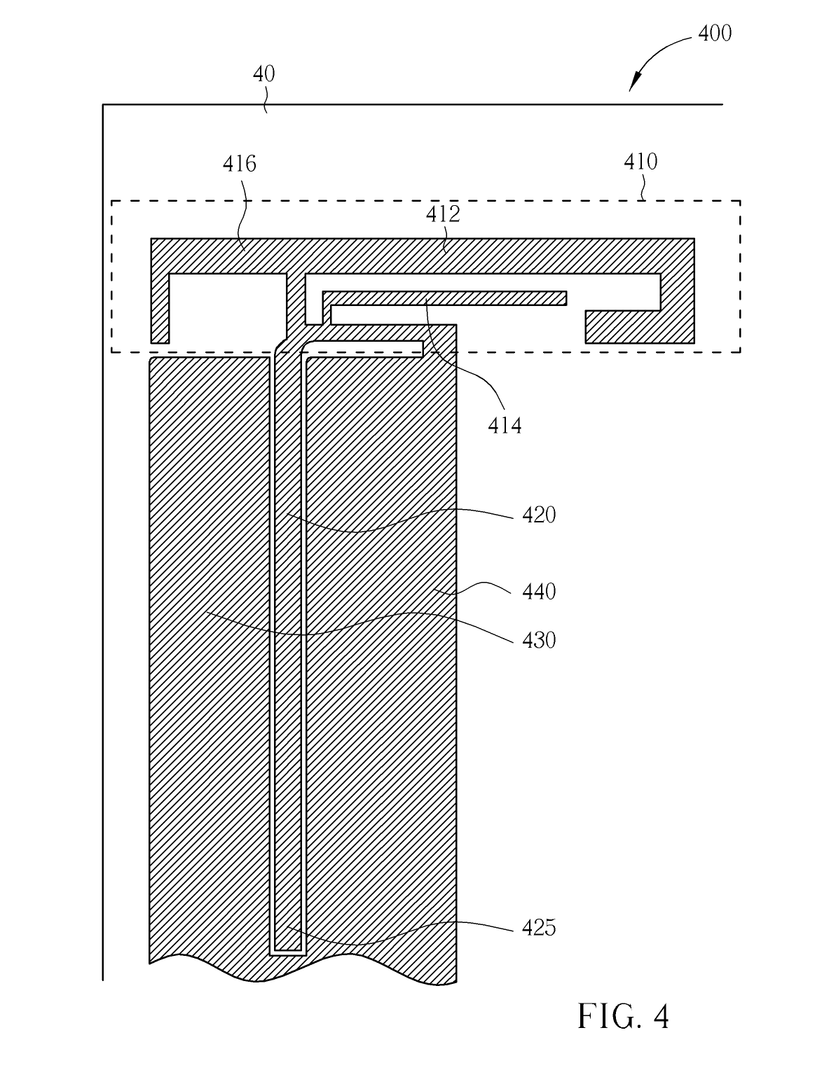

Please refer to FIG. 4, which is a schematic diagram of an antenna 400 according to an embodiment of the invention. The antenna 400 is formed between a notebook front casing (substrate) 40 and the film thereof, and includes a radiator 410, a feeding signal line 420 and grounding patterns 430 and 440. The feeding signal line 420 and grounding patterns 430 and 440 form a co-planer waveguide feeding pattern which utilizes the grounding patterns 430 and 440 to surround the feeding signal line 420 for maintaining signal strength transmitted on the feeding signal line 420 and signal bandwidth. By the co-planer waveguide, the invention can decrease consumption of the feeding cable, so as to lower the cost.

In addition, a bottom 425 of the feeding signal line 420 is used as a feeding terminal, and can be connected to the metal spring or directly connected to the feeding cable. The radiator 410 is a multiple-band radiator and is divided into multi-signal paths by a contact with the feeding signal line 420. The signal paths from long to short is provided by radiation sections 412, 414 and 416 in sequence for transmitting and receiving signals from lower to higher frequencies.

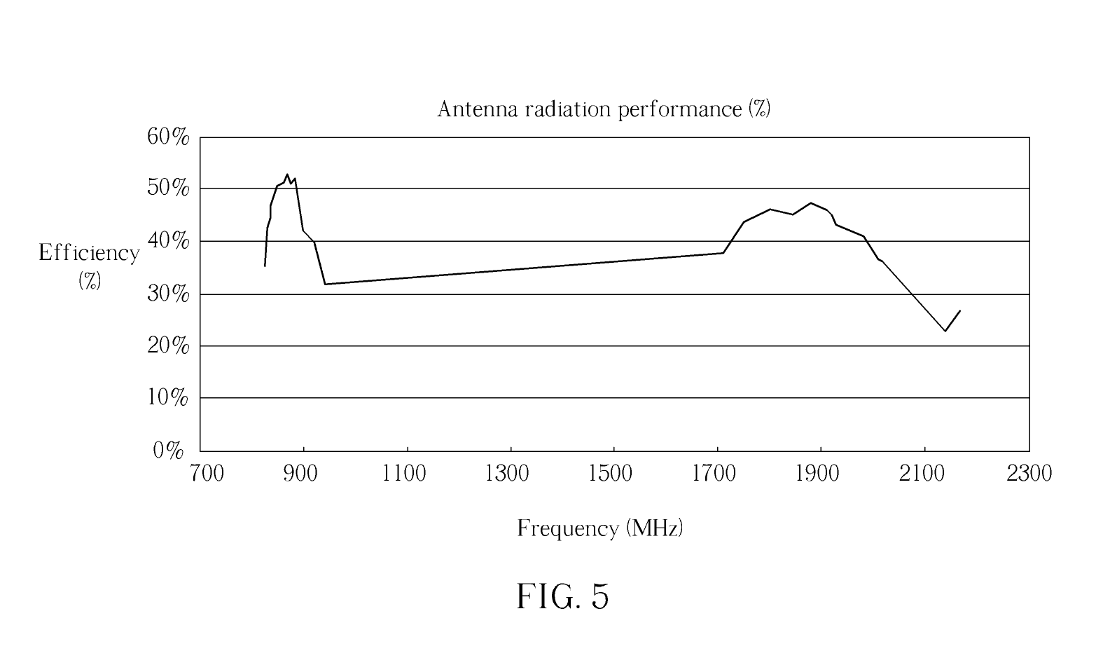

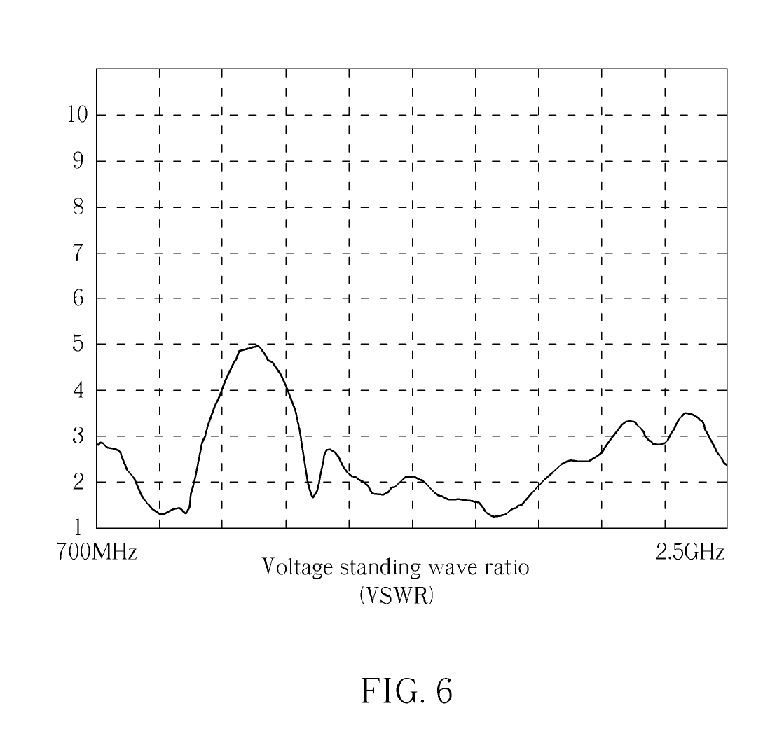

The antenna 400 can be used in a wireless wide area network (WWAN) communication product, and can transmit and receive signals defined by various communication standards, such as worldwide interoperability for microwave access (WIMAX), universal mobile telecommunications system (UMTS), code division multiple access (CDMA2000), global system for mobile communications (GSM), 3rd generation wireless communication system, etc. The radiation section 412 can be used for receiving and transmitting signals in frequency band 800 and 900 MHz. The radiation section 414 can be used for receiving and transmitting signals in 1800 and 1900 MHz. The radiation section 416 can be used for receiving and transmitting signals in 2 GHz. In this condition, radiation performance and voltage standing wave ratio (VSWR) of the antenna 400 in different frequencies can be referred in FIGS. 5 and 6.

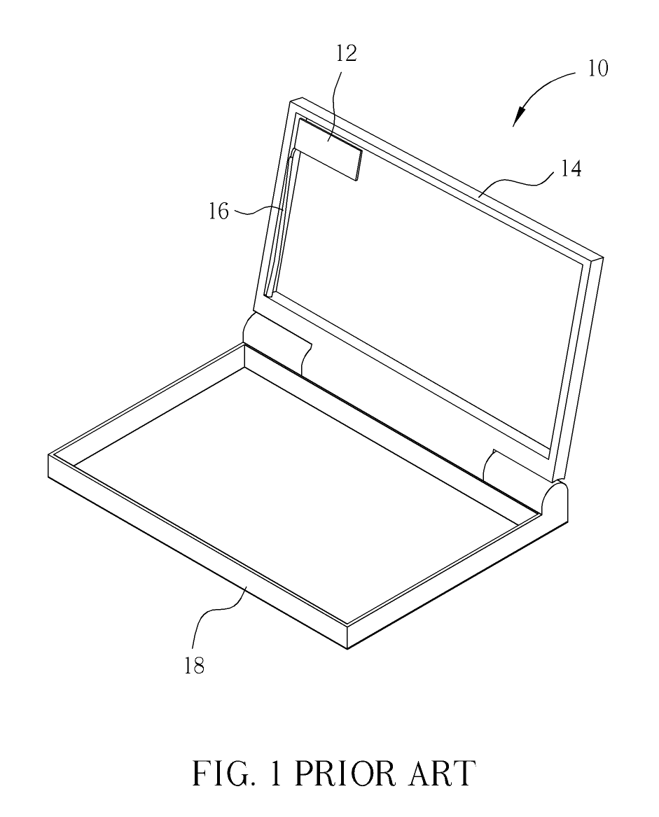

In conclusion, the embodiments of the invention print the antenna pattern on the casing film of the communication product by sliver ink, which costs less than the manufacturing methods using iron piece or PCB. For further cost deduction, the embodiments of the invention employ co-planer waveguide feeding antennas to save 50-80% of feeding cable material than the conventional antenna of FIG. 1. Furthermore, since the antenna is printed on the film of the casing, the space available for the antenna is larger than the conventional antenna, and the antenna of the invention has better performance.

Those skilled in the art will readily observe that numerous modifications and alterations of the device and method may be made while retaining the teachings of the invention.

What is claimed is:

1. An antenna manufacturing method comprising:
printing an antenna pattern on a film, wherein the antenna pattern comprises a radiation pattern and a feeding terminal; and
forming a substrate on the film via an in-mold forming process.

2. The method of claim 1 further comprising:
proving a connecting spring embedded in the substrate to couple with the feeding terminal; and
welding a feeding cable to couple with the connecting spring.

3. The method of claim 1, wherein the antenna pattern further comprises a co-planer waveguide feeding pattern coupled between the radiation pattern and the feeding terminal.

4. The method of claim 1, wherein the radiation pattern is a single-band or multiple-band radiation pattern.

5. The method of claim 1, wherein the antenna pattern is printed with silver ink.
